(19) United States
(12) Patent Application Publication
(10) Pub. No.: US 2023/0269118 A1
(43) Pub. Date: Aug. 24, 2023

(54) Single wire serial communication using pulse width modulation in a daisy chain architecture

(71) Applicants: FormFactor, Inc., Livermore, CA (US); Cirel Systems Private Limited, Bangalore (IN)

(72) Inventors: Roy J. Henson, Pleasanton, CA (US); Hackjin Kim, Pleasanton, CA (US); Leela Madhav Lakkimsetti, Bangalore (IN)

(21) Appl. No.: 18/114,087

(22) Filed: Feb. 24, 2023

Related U.S. Application Data
(60) Provisional application No. 63/313,619, filed on Feb. 24, 2022.

(51) Int. Cl. H04L 25/49; H04L 7/027

(52) U.S. Cl. CPC H04L 25/4902; H04L 7/027

(57) ABSTRACT

Improved serial communication is provided in a system where each node regenerates data and transmits it to at least one other node in the system. Pulse width modulation (PWM) is used to encode the data. Preferably, all pulse shapes of the PWM start with a synchronization feature. It is also preferred that the regeneration delay in each node be less than the system clock period.

### CROSS REFERENCE TO RELATED APPLICATIONS

This application claims priority from U.S. Provisional Patent Application 63/313,619 filed Feb. 24, 2022, which is incorporated herein by reference.

### FIELD OF THE INVENTION

This invention relates to serial communication where each node regenerates data for transmission to other nodes.

### BACKGROUND

Serial data links are often used in embedded systems where several devices need to communicate with each other. In cases where these devices are small/low power devices with low pin counts, a conventional SPI (Serial Peripheral Interface) link with 4 to 5 wires and 2 pins for power is a large overhead. Thus it would be an advance in the art to provide less burdensome serial communications.

### SUMMARY

An exemplary embodiment is a single wire replicating serial data link using PWM (Pulse Width Modulation) for digital communication. From the source data is transmitted as a stream of pulses with a wide pulse equal to a logic “1” and a narrow pulse equal to logic “0” (or vice versa).

Advantages over a conventional 4/5 wire SPI link include:

Fewer pins used—better suited to low pin count devices.

Easy printed circuit board routing.

Compared to a shift register type chain, the latency per device can be just one bit period, so all devices in the chain can act quickly to the data sent.

Advantages over a repeating Manchester Encoded serial link include:

This approach doesn't require high accuracy clocks for data recovery and data regeneration. The clocks can be synchronized to the start of every pulse, and only need to be “accurate/stable” for the period of one bit, rather than a longer data stream.

Accuracy of the bit period is less critical.

### BRIEF DESCRIPTION OF THE DRAWINGS

FIG. 1 shows a block diagram of an embodiment of the invention.

FIG. 2 shows an exemplary pulse width modulation format.

FIG. 3 shows some data formatting options.

FIG. 4 is a block diagram of an exemplary data regenerator.

FIG. 5 is a timing diagram relating to the example of FIG. 4.

### DETAILED DESCRIPTION

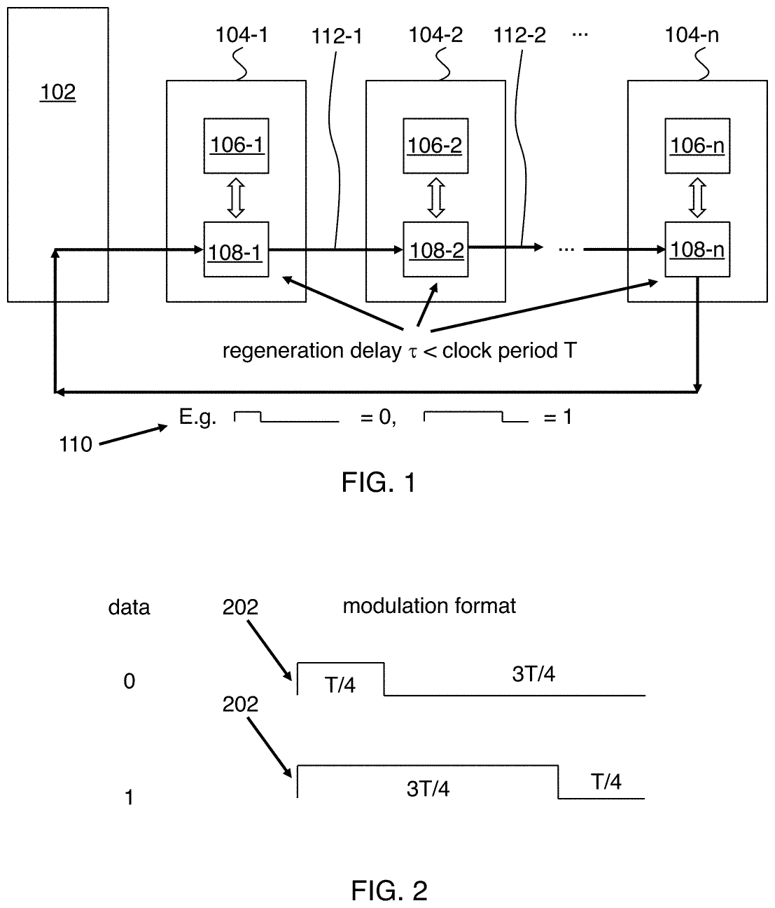

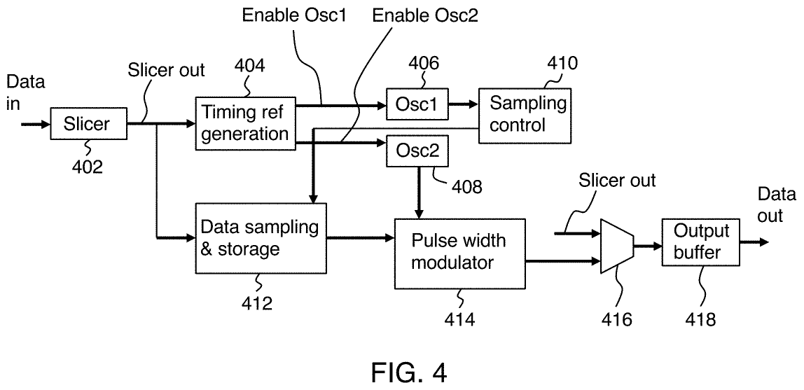

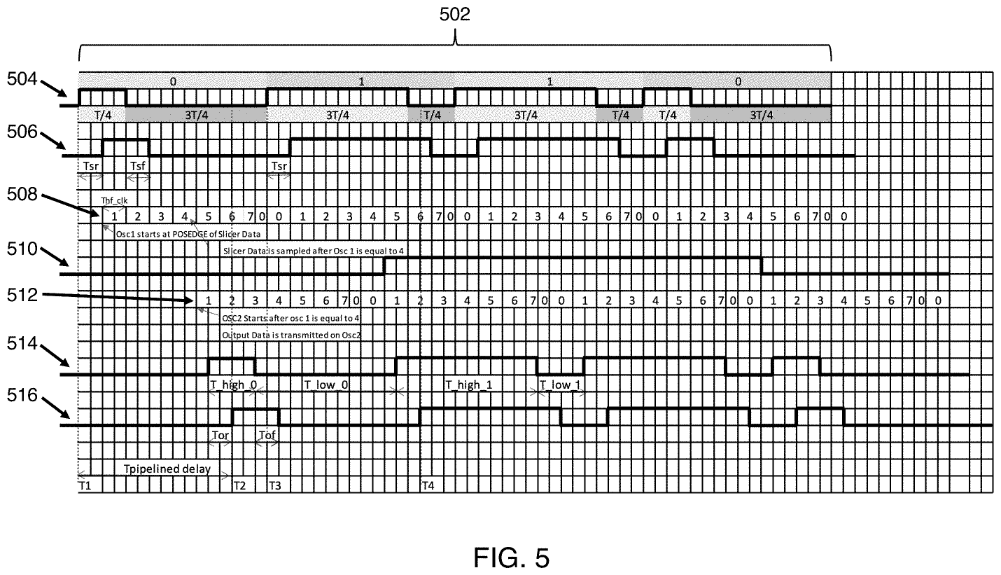

FIG. 1 shows an exemplary embodiment of the invention. This example includes controller 102 and two or more nodes 104-1, 104-2, . . . , 104-n. Controller 102 will typically be an microcontroller or FPGA (field programmable gate array) that is capable of generating and reading multiple PWM signals. One controller can control one or more serial links as considered herein. Each node includes a corresponding data regenerator 108-1, 108-2, . . . , 108-n. The remaining parts of each node are designated 106-1, 106-2, . . . , 106-n and can include any circuits or devices. It will be convenient to refer to these parts of the nodes as “controlled circuits”. The nodes are connected with two or more serial data links 112-1, 112-2, . . . etc. Digital data on the two or more serial data links is encoded with pulse width modulation, for example modulation format 110. Each node is configured to regenerate received data to provide regenerated data and to transmit the regenerated data to one or more other nodes. The example of FIG. 1 shows a daisy chain architecture, but nodes are not limited to only transmitting to a single other node. Such transmission can be to multiple nodes, thereby creating a tree architecture. An important feature of some preferred embodiments is that the regeneration delay τ can be less than the clock period T. This capability is explained below in connection with the example of FIGS. 4-5.

The present approach can be applied in any situation where serial communication is needed. However, it can be particularly advantageous for embedded systems and the like, where the components being connected are small-scale enough (e.g., sub-parts of an integrated circuit chip) that the overhead of more conventional serial communication is burdensome. Preferably, the two or more serial data links are single-wire, half-duplex links.

FIG. 2 shows more details of a preferred modulation format, which is binary (2-symbol) pulse width modulation. Here T is the system clock period. Preferably, every pulse shape of the pulse width modulation (PWM) starts with a synchronization feature (in this example, the synchronization feature is rising edge 202). Each node's data regenerator can include a local clock, and the local clocks can be synchronized to the synchronization feature of the pulse width modulation. In this way, there is no need for a separate clock line in the serial data links, and the local clocks for data recovery and data generation need not be especially stable, since they get re-synchronized every system clock cycle. Naturally, the roles of 0 and 1 can be interchanged in the example of FIG. 2, and many other pulse width modulation pulse shapes are also possible. It is preferred, as seen in the following example, to use PWM pulse shapes such that a receiver can determine which symbol was transmitted well before reception of the current PWM shape is complete. This preference leads to the above-mentioned preference for binary PWM, since if the number of symbols is larger than two, it is more difficult to determine what was transmitted based on partial reception of the corresponding PWM shape, thereby increased pipeline delay. Non-binary PWM would also undesirably increase the required oscillator accuracy in the local clocks.

Thus this example is a single wire replicating serial data link using PWM (Pulse Width Modulation) for digital communication. From the source data is transmitted as a stream of pulses with a wide pulse equal to a logic “1” and a narrow pulse equal to logic “0” (or vice versa). Additionally pulses of different width could be made to represent multiple bits—however this would increase the oscillator accuracy needed and also increase the pipeline delay.

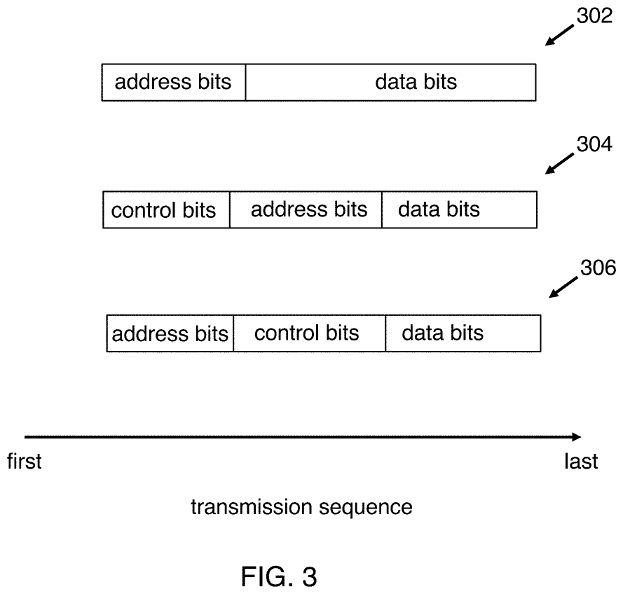

The pulse stream is regenerated at each node before then being transmitted to the next node. See FIG. 1. The data transmitted can contain both node address and data/control information. Any conventional addressing scheme can be used. A preferred addressing approach is to structure the serial data such that in each word of the serial data stream, the address bits arrive before the data bits (see 302 on FIG. 3). Optionally, control bits can come before the address bits (see 304 on FIG. 3), or between the address bits and the data bits (see 306 on FIG. 3).

FIG. 4 is a simplified block diagram of an exemplary data regenerator. Here the local clock is provided by two oscillators Osc1 (406) and Osc2 (408) running at 8× the system clock period. Typical clock periods can be 100 ns or 200 ns. For completeness, the remaining components on FIG. 4 are slicer 402, timing reference generation 404, sampling control 410, data sampling and storage 412, pulse width modulator 414, multiplexer 416, and output buffer 418. In this example, after power up an initialization is done where the output of the slicer is applied directly to the output. This period of direct connection is used to detect if we have AC or DC coupling between devices. Fine tuning and synchronization of the Oscillators occurs during the preamble at the start of every major communication sequence.

Osc1 is triggered by the rising edge of the input data and is used to sample it at a count of 4 (mid period). Osc2 is started when Osc1=4 and is used to time the output pulse—2 counts if a low was sampled or 6 counts if a high was sampled.

FIG. 5 shows the resulting timing diagram. Here 502 is an exemplary bit sequence “0110” and 504 is the corresponding PWM input data. Tsr and Tsf are the rise and fall times of the slicer, so 506 is the slicer output. The count sequence of Osc1 is referenced as 508, and the corresponding sampled data is shown as 510. Here we see that transitions in sampled data 510 occur only at Osc1 counts of 4 (mid-period, as indicated above). The count sequence of Osc2 is referenced as 512 and the corresponding encoded data is shown as 514. The output data is shown as 516, and accounts for the output buffer rise and fall times Tor and Tof, respectively.

Other notations on FIG. 5 are as follows: Thf_clk is the period of the internal high frequency clock of the nodes (not to be confused with the system clock period T), T_high_0 is the encoded data high time for bit 0=2*Thf_clk, T_high_1 is the encoded data high time for bit 1=6*Thf_clk, T_low_0 is the encoded data low time for bit 0=6*Thf_clk, and T_low_1 is the encoded data low time for bit 1=2*Thf_clk. Important reference times are as follows: T1 is the rising edge of the input data, T2 is the corresponding rising edge of the output data, T3-T1 is the input bit duration, and T4-T2 is the output bit duration (both these durations are actually the system clock period T, so we're really defining T3 and T4 here).

The pipeline delay T_pipelined delay=T2−T1, and this is also equal to Tsr+4*Thf_clk+Tor. As indicated above (and as shown on FIG. 5), this pipeline delay is preferably less than the clock period T. Another way of expressing this desirable feature is that the start time of output bit 0 (T2) is before the end of input bit 0 (T3).

Further advantages of this exemplary embodiment are lack of sensitivity to rise and fall times, and no accumulation of error as data is passed from node to node in a chain.

1. Apparatus comprising:
two or more nodes;
two or more serial data links configured to connect the two or more nodes;
wherein digital data on the two or more serial data links is encoded with pulse width modulation;
wherein each of the two or more nodes is configured to regenerate received data to provide regenerated data and to transmit the regenerated data to one or more of the two or more nodes.

2. The apparatus of claim 1, wherein a regeneration delay of at least one of the two or more nodes is less than a clock period.

3. An embedded system including the apparatus of claim 1.

4. The apparatus of claim 1, wherein the pulse width modulation is binary pulse width modulation.

5. The apparatus of claim 1, wherein every pulse shape of the pulse width modulation starts with a synchronization feature.

6. The apparatus of claim 5, wherein each node includes a local clock, and wherein each node synchronizes its local clock to the synchronization feature of the pulse width modulation.

7. The apparatus of claim 1, wherein the two or more serial data links are single-wire, half-duplex links.

8. The apparatus of claim 1, wherein a format of the digital data has address bits precede data bits.

9. The apparatus of claim 8, wherein a format of the digital data has control bits precede the address bits.

10. The apparatus of claim 8, wherein a format of the digital data has control bits precede the data bits and follow the address bits.
